(19) United States
(12) Patent Application Publication
(10) Pub. No.: US 2026/0194918 A1
(43) Pub. Date: Jul. 9, 2026

(54) VENT STACK TEST CAP REMOVAL SYSTEM AND METHOD

(71) Applicant: Daniel Guerin, Thornville, OH (US)

(72) Inventor: Daniel Guerin, Thornville, OH (US)

(21) Appl. No.: 19/012,486

(22) Filed: Jan. 7, 2025

(51) Int. Cl. G05D 1/689; B64U 10/13; B64U 101/26; G05D 1/224; G05D 1/622; G05D 105/05; G05D 109/25; G06V 10/74; G06V 20/17; H04N 7/18

(52) U.S. Cl. CPC G05D 1/689; B64U 10/13; G05D 1/2247; G05D 1/622; G06V 10/74; G06V 20/17; H04N 7/183; B64U 2101/26; B64U 2201/20; G05D 2105/05; G05D 2109/254

(57) ABSTRACT

A non-transitory computer-readable medium may store instructions that, when executed by a processor of an unmanned aerial vehicle (UAV), may cause the UAV to perform operations. The operations may include navigating to an approximate location of a plumbing vent stack. A camera may be activated to scan an area for the plumbing vent stack. The plumbing vent stack may be identified using imagery from the camera. The UAV may be positioned proximate to the identified plumbing vent stack. A cap removal mechanism may be engaged with a test cap on the plumbing vent stack. The cap removal mechanism may be activated to remove the test cap from the plumbing vent stack. The cap removal mechanism may comprise melting the test cap using a heating element or cutting the test cap using a mechanical cutting tool. The removed test cap may be captured with a retention mechanism on the UAV and transported to a disposal location.

### TECHNICAL FIELD

The present disclosure relates generally to plumbing maintenance systems and methods, and more particularly to systems and methods for removing test caps from plumbing vent stacks.

### BACKGROUND

Plumbing systems in buildings typically include vent stacks that extend through the roof to allow proper venting of the plumbing system. During construction or maintenance, these vent stacks may be temporarily sealed with test caps. Removal of these test caps often requires a plumber to physically access the roof, which can present safety risks and inefficiencies.

Traditional methods for removing test caps from plumbing vent stacks involve a plumber climbing onto the roof, often using a ladder and safety harness. The plumber then walks on the roof to locate each vent stack, uses a saw or other tool to cut through the test cap, and then returns to the ground with the removed caps. This process can be time-consuming, potentially dangerous, and may require additional safety equipment and precautions. There is a need for improved systems and methods for removing test caps from plumbing vent stacks that enhance safety and efficiency in plumbing maintenance operations.

### BRIEF OVERVIEW

The present disclosure provides systems, methods, and devices for removing test caps from plumbing vent stacks. In various embodiments, an unmanned aerial vehicle (UAV) or drone may be equipped with a cap removal mechanism and navigation systems to locate and remove test caps from vent stacks without requiring a human operator to physically access the roof. It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items. The accompanying drawings, which are incorporated in and constitute a part of this specification, illustrate embodiments of the disclosure and, together with a general description of the disclosure given above, and the detailed description given below, serve to explain the principles of the disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. The present disclosure, in accordance with one or more various embodiments, is described in detail with reference to the following figures. The drawings are provided for purposes of illustration only and merely depict typical or example embodiments of the disclosure. These drawings are provided to facilitate the reader's understanding of the disclosure and shall not be considered limiting of the breadth, scope, or applicability of the disclosure.

FIG. 1 is a perspective view of an exemplary unmanned aerial vehicle (UAV) configured for vent stack test cap removal, in accordance with embodiments of the present disclosure.

FIG. 2 is a block diagram illustrating components of an exemplary UAV system for vent stack test cap removal, in accordance with embodiments of the present disclosure.

FIG. 3 is a flowchart depicting an exemplary method for removing a test cap from a vent stack using a UAV, in accordance with embodiments of the present disclosure.

FIG. 4 is a schematic illustration of a user interface for controlling a UAV configured for vent stack test cap removal, in accordance with embodiments of the present disclosure.

FIGS. 5A and 5B are cross-sectional views of exemplary cap removal mechanisms engaging a test cap on a vent stack, in accordance with embodiments of the present disclosure.

### DETAILED DESCRIPTION

The present disclosure is described with reference to the accompanying drawings. The drawing in which an element first appears is typically indicated by the leftmost digit(s) in the corresponding reference number. In the following description, numerous specific details are set forth to provide a thorough understanding of various embodiments. However, it will be understood by those skilled in the art that the various embodiments may be practiced without these specific details. In other instances, well-known methods, procedures, components, and circuits have not been described in detail so as not to obscure the particular embodiments.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification and the claims, the terms “comprise,” “comprising,” “include,” “including,” and the like are to be understood to imply the inclusion of stated elements but not the exclusion of any other elements. The term “exemplary” is used in the sense of “example” rather than “ideal” or “model.” As used herein, the terms “about” or “approximately” apply to all numeric values, whether or not explicitly indicated. These terms generally refer to a range of numbers that one of skill in the art would consider equivalent to the recited values (i.e., having the same function or result).

The terms used in this specification generally have their ordinary meanings in the art, within the context of this disclosure, and in the specific context where each term is used. Certain terms are discussed below, or elsewhere in the specification, to provide additional guidance to the practitioner regarding the description of the disclosure. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

### DEFINITIONS

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise. As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result. The following description of various embodiments is merely exemplary in nature and is in no way intended to limit the disclosure, its application, or uses.

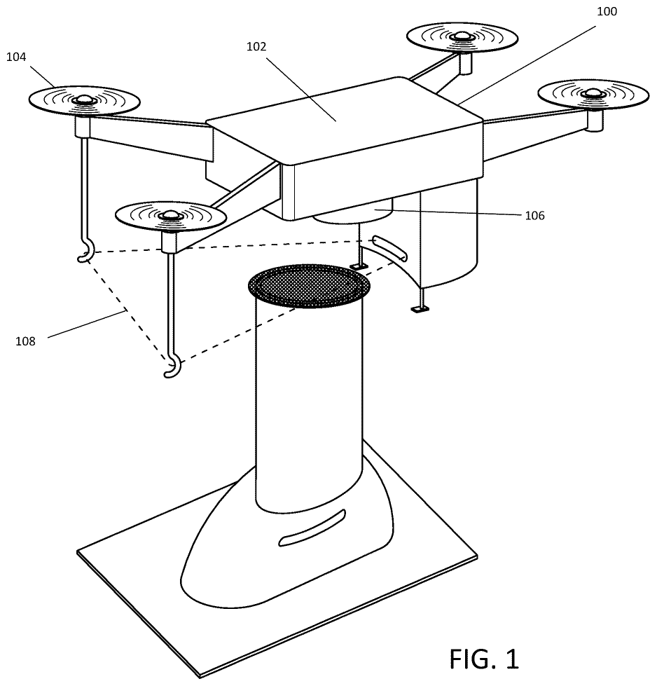

Referring now to FIG. 1, a perspective view of an exemplary unmanned aerial vehicle (UAV) 100 configured for vent stack test cap removal is illustrated, in accordance with embodiments of the present disclosure. The UAV 100 may include a frame 102 supporting multiple rotors 104 for propulsion and maneuvering. A camera 106 may be mounted on the frame 102 for visual navigation and identification of vent stacks. A cap removal mechanism 108 may be attached to the lower portion of the frame 102, configured to engage and remove test caps from vent stacks.

The UAV 100 may be designed to operate autonomously or under remote control by a user. The frame 102 may be constructed from lightweight materials such as carbon fiber or aluminum to maximize flight time and payload capacity. The rotors 104 may be powered by electric motors, with the number and configuration of rotors optimized for stability and maneuverability in various wind conditions. The camera 106 may be a high-resolution digital camera capable of capturing both still images and video. It may be mounted on a gimbal to provide stable imagery during flight and may incorporate features such as zoom and infrared capabilities to enhance vent stack identification under various lighting and weather conditions. The cap removal mechanism 108 may include a heating element or cutting tool designed to safely and effectively remove test caps from vent stacks. This mechanism may be attached to the UAV 100 via compliant support hooks, allowing for secure positioning during the cap removal process.

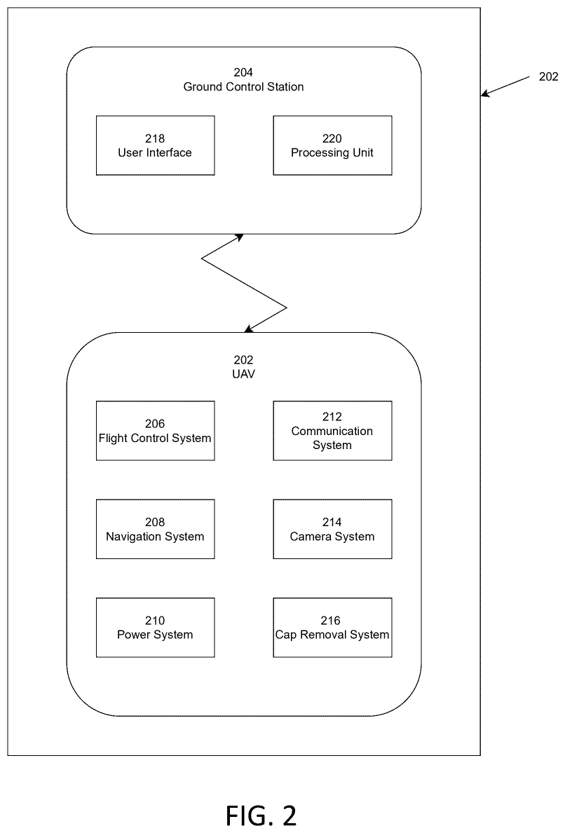

FIG. 2 is a block diagram illustrating components of an exemplary UAV system 200 for vent stack test cap removal, in accordance with embodiments of the present disclosure. The system 200 may include a UAV 202 and a ground control station 204 in communication with each other. The UAV 202 may include a flight control system 206, a navigation system 208, a power system 210, a communication system 212, a camera system 214, and a cap removal system 216. These systems may work in concert to enable the UAV 202 to locate, approach, and remove test caps from vent stacks.

The flight control system 206 may manage the UAV's propulsion and maneuvering, interpreting commands from the navigation system 208 or the ground control station 204 to adjust rotor speeds and maintain stable flight. The navigation system 208 may include GPS receivers, inertial measurement units, and other sensors to determine the UAV's position and orientation. It may work in conjunction with the camera system 214 to identify and navigate to vent stacks. The power system 210 may include batteries and power distribution components to supply electricity to all onboard systems. It may also incorporate power management features to optimize flight time and mission duration. The communication system 212 may enable bidirectional data transfer between the UAV 202 and the ground control station 204. This may include transmission of control commands, telemetry data, and video feeds. The camera system 214 may include one or more cameras and associated image processing hardware and software. It may be used for visual navigation, vent stack identification, and monitoring of the cap removal process. The cap removal system 216 may include the mechanical and electrical components necessary for removing test caps from vent stacks. This may encompass heating elements, cutting tools, and associated control mechanisms. The ground control station 204 may include a user interface 218 and a processing unit 220. The user interface 218 may allow an operator to control the UAV 202, view camera feeds, and monitor system status. The processing unit 220 may handle data processing, mission planning, and coordination of UAV operations.

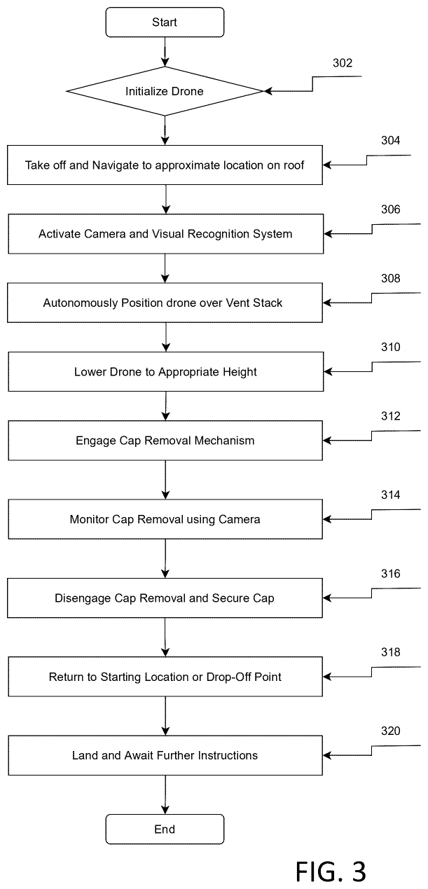

FIG. 3 is a flowchart depicting an exemplary method 300 for removing a test cap from a vent stack using a UAV, in accordance with embodiments of the present disclosure. The method 300 may begin at step 302 with the initialization of the UAV system. This may involve powering on the UAV, establishing communication with the ground control station, and performing pre-flight checks. At step 304, the UAV may take off and navigate to the approximate location of the target vent stack. This navigation may be based on GPS coordinates, user input, or pre-programmed flight paths. In step 306, the UAV may activate its onboard camera and visual recognition system to scan the roof area and identify the specific vent stack targeted for cap removal. This may involve image processing algorithms to distinguish vent stacks from other roof features.

Once the vent stack is identified, the UAV may autonomously position itself over the vent stack in step 308. This positioning may involve fine adjustments to the UAV's location and altitude to ensure proper alignment for cap removal. At step 310, the UAV may lower itself to the appropriate height for cap removal. This height may be determined based on the specific cap removal mechanism employed and the dimensions of the vent stack. In step 312, the cap removal mechanism may be engaged. This may involve activating a heating element to melt the cap, engaging a cutting tool to mechanically remove the cap, or employing another suitable removal technique. The UAV may monitor the cap removal process using its camera system in step 314. This monitoring may allow for real-time adjustments to the removal process and verification of successful cap removal. Once the cap is removed, the UAV may disengage the cap removal mechanism in step 316. Depending on the system configuration, this step may also involve securing the removed cap for transport. In step 318, the UAV may return to its starting location or a designated drop-off point. This may involve navigating back to the ground control station or another predetermined location. Finally, at step 320, the UAV may land and await further instructions. This may include shutting down systems, transferring collected data, or preparing for the next mission.

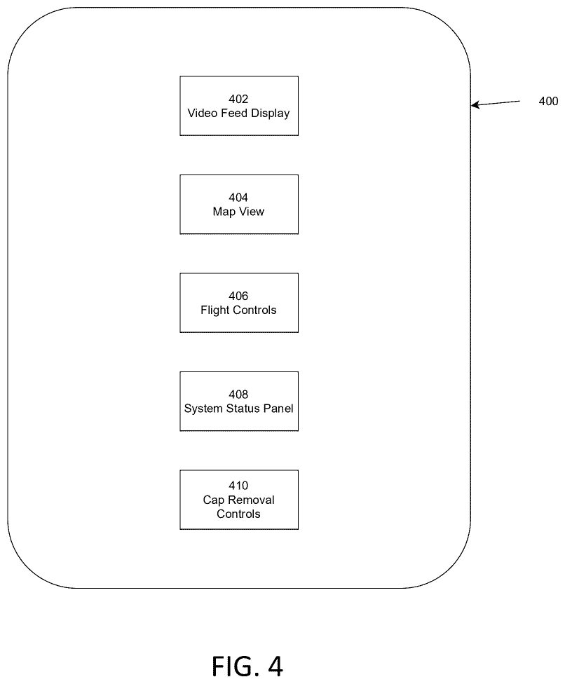

FIG. 4 is a schematic illustration of a user interface 400 for controlling a UAV configured for vent stack test cap removal, in accordance with embodiments of the present disclosure. The user interface 400 may be displayed on a smartphone, tablet, or other suitable device at the ground control station. The user interface 400 may include a video feed display 402 showing real-time imagery from the UAV's camera. This display may assist the operator in identifying vent stacks and monitoring the cap removal process. A map view 404 may show the UAV's current position and planned flight path. This view may allow the operator to plan and adjust missions as needed. Flight controls 406 may provide options for takeoff, landing, and manual flight adjustments. These controls may be used to override autonomous functions when necessary. A system status panel 408 may display critical information such as battery level, GPS signal strength, and communication link quality. This information may help the operator monitor the UAV's health and capabilities during the mission. Cap removal controls 410 may allow the operator to initiate and monitor the cap removal process. These controls may include options to engage the heating element or cutting tool, adjust removal parameters, and confirm successful cap removal.

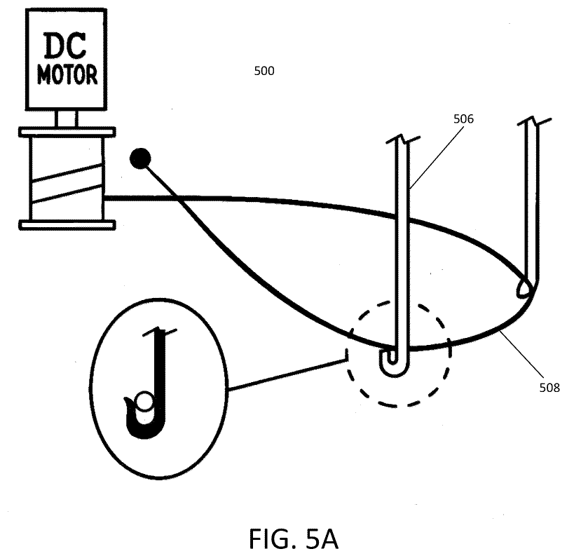

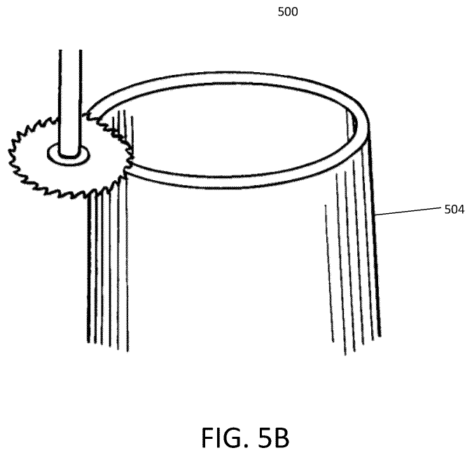

FIGS. 5A and 5B are cross-sectional views of an exemplary cap removal mechanism 500 engaging a test cap (not shown) on a vent stack 504, in accordance with embodiments of the present disclosure. The cap removal mechanism 500 may be attached to the UAV (not shown) via compliant support hooks 506. The cap removal mechanism 500 may include a heating element 508 or a cutting tool, depending on the specific embodiment. The heating element 508 may be designed to apply controlled, sufficient heat to gradually melt through the test cap. The compliant support hooks 506 may securely hold the cap removal mechanism 500 clear until the UAV is resting in the cutting position. As the heating element 508 or cutting tool begins to engage the test cap, it may draw into a slot on the vent stack 504, eventually pulling free from the compliant support hooks 506. This allows the cap removal mechanism 500 to grip the vent stack 504 firmly and begin the cap removal process. The cap removal mechanism 500 may also incorporate sensors or cameras to monitor the removal process and ensure complete separation of the test cap 502 from the vent stack 504.

It should be understood that the embodiments described herein are exemplary and that a person skilled in the art may make many variations and modifications without departing from the spirit and scope of the disclosure. All such variations and modifications are intended to be included within the scope of the disclosure as defined in the appended claims.

While illustrative embodiments of the invention have been shown and described, variations and alternative embodiments may occur to those skilled in the art. Such variations and alternative embodiments may be made without departing from the scope of the invention as defined in the claims.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom.

Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112(f), unless the element is expressly recited using the exact phrase “means for . . . ” and no method or process step herein is to be construed under the provisions of 35 U.S.C. section 112(f) unless the step, or steps, are expressly recited using the exact phrase “step(s) for . . . ”.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. Insofar as the description above and the accompanying drawing disclose any additional subject matter that is not within the scope of the claims below, the disclosures are not dedicated to the public and the right to file one or more applications to claims such additional disclosures is reserved.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention. It should be understood that the above-described embodiments are illustrative of only a few of the possible specific embodiments which can represent applications of the principles of the present disclosure. Numerous and varied other arrangements can be readily devised by those skilled in the art without departing from the spirit and scope of the disclosure.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A system for removing a test cap from a plumbing vent stack, the system comprising:
an unmanned aerial vehicle (UAV) comprising:
a frame;
a plurality of rotors attached to the frame for propulsion and maneuvering;
a camera mounted on the frame;
a cap removal mechanism attached to the frame; and
a control system configured to:
navigate the UAV to a location of a plumbing vent stack;
identify the plumbing vent stack using imagery from the camera;
position the UAV proximate to the plumbing vent stack; and
activate the cap removal mechanism to remove a test cap from the plumbing vent stack.

2. The system of claim 1, wherein the cap removal mechanism comprises a heating element configured to melt the test cap.

3. The system of claim 1, wherein the cap removal mechanism comprises a cutting tool configured to mechanically remove the test cap.

4. The system of claim 1, further comprising compliant support hooks attaching the cap removal mechanism to the frame.

5. The system of claim 1, further comprising a ground control station in communication with the UAV, the ground control station comprising a user interface for controlling the UAV and monitoring the cap removal process.

6. The system of claim 5, wherein the user interface comprises:
a video feed display showing real-time imagery from the camera;
a map view showing a current position and planned flight path of the UAV;
flight controls for manual adjustment of the UAV's flight; and
cap removal controls for initiating and monitoring the cap removal process.

7. The system of claim 1, wherein the control system is further configured to:
monitor the cap removal process using imagery from the camera; and
adjust the position of the UAV or operation of the cap removal mechanism based on the monitoring.

8. A method for removing a test cap from a plumbing vent stack, the method comprising:
navigating an unmanned aerial vehicle (UAV) to an approximate location of a plumbing vent stack;
activating a camera on the UAV to scan an area for the plumbing vent stack;
identifying the plumbing vent stack using imagery from the camera;
positioning the UAV proximate to the identified plumbing vent stack;
engaging a cap removal mechanism on the UAV with a test cap on the plumbing vent stack; and
activating the cap removal mechanism to remove the test cap from the plumbing vent stack.

9. The method of claim 8, further comprising:
monitoring the cap removal process using the camera on the UAV; and
adjusting the position of the UAV or operation of the cap removal mechanism based on the monitoring.

10. The method of claim 8, wherein engaging the cap removal mechanism comprises lowering the UAV until the cap removal mechanism contacts the test cap.

11. The method of claim 8, wherein activating the cap removal mechanism comprises melting the test cap using a heating element.

12. The method of claim 8, wherein activating the cap removal mechanism comprises cutting the test cap using a mechanical cutting tool.

13. The method of claim 8, further comprising:
capturing the removed test cap with a retention mechanism on the UAV; and
transporting the removed test cap to a disposal location.

14. The method of claim 8, further comprising:
receiving user input via a ground control station to initiate the cap removal process; and
transmitting status updates to the ground control station during the cap removal process.

15. The method of claim 8, wherein identifying the plumbing vent stack comprises:
analyzing imagery from the camera using visual recognition algorithms; and
comparing detected features to a database of known plumbing vent stack designs.

16. The method of claim 8, further comprising:
detecting obstacles in a flight path of the UAV; and
automatically adjusting the flight path to avoid the detected obstacles.

17. A non-transitory computer-readable medium storing instructions that, when executed by a processor of an unmanned aerial vehicle (UAV), cause the UAV to perform operations comprising:
navigating to an approximate location of a plumbing vent stack;
activating a camera to scan an area for the plumbing vent stack;
identifying the plumbing vent stack using imagery from the camera;
positioning the UAV proximate to the identified plumbing vent stack;
engaging a cap removal mechanism with a test cap on the plumbing vent stack; and
activating the cap removal mechanism to remove the test cap from the plumbing vent stack.

18. The non-transitory computer-readable medium of claim 17, wherein the operations further comprise:
monitoring the cap removal process using the camera; and
adjusting the position of the UAV or operation of the cap removal mechanism based on the monitoring.

19. The non-transitory computer-readable medium of claim 17, wherein engaging the cap removal mechanism comprises lowering the UAV until the cap removal mechanism contacts the test cap.

20. The non-transitory computer-readable medium of claim 17, wherein the operations further comprise:
capturing the removed test cap with a retention mechanism; and
transporting the removed test cap to a disposal location.
